(19) United States
(12) Patent Application Publication
(10) Pub. No.: US 2019/0103744 A1
(43) Pub. Date: Apr. 4, 2019

(54) SMART HOME POWER SHARING CONTROLLER

(71) Applicant: Anthony Gaeto, Odessa, FL (US)

(72) Inventor: Anthony Gaeto, Odessa, FL (US)

(21) Appl. No.: 15/720,431

(22) Filed: Sep. 29, 2017

(51) Int. Cl. H02J 3/14; G05B 15/02; H02J 3/38; H02J 13/00; H02J 7/35; H02J 7/00

(52) U.S. Cl. CPC H02J 3/14; G05B 15/02; H02J 3/381; H04W 4/008; H02J 7/35; H02J 7/0013; H02J 2003/143; H02J 13/0017

(57) ABSTRACT

A system for regulating power consumption that comprises a computer control unit operating a software application and integrated with an electric fuse panel and breaker panel and also connected to a plurality of power modules for controlling electrical power delivered to a second group of electrical appliances. The software application can be used to configure the control unit with a hierarchy value of need assigned to each electrical appliance in the second group of electrical appliances. The software application is also configured to operate on a computerized mobile device, so the mobile device can interface with and control the control unit. The control unit monitors power availability and usage from a plurality of power sources, monitors electrical usage by a first group of electrical appliances, and controls the second group of electrical appliances by decreasing the power delivered or the need for power according to the value of need.

### CROSS-REFERENCE TO RELATED APPLICATION(S)

Not applicable

### BACKGROUND OF THE INVENTION

### 1. Field of Invention

The present invention relates to the field of power monitoring and control in smart home and computer optimized power sources, and more particularly to monitoring and controlling electrical use from multiple sources in multiple home appliances and systems.

### 2. Description of Related Art

Increasingly, houses and vehicles are utilizing multiple different power sources to power electrical appliances and systems. Computers control and monitor electrical usage, distribution, and consumption in these evolving systems, to optimize electrical usage to most efficiently use the available electrical energy.

In many modern precepts of living within the smallest carbon footprint as possible, efficiency drives many aspects of daily living. Appliances can be minimally powered with reduced amperage when required while other systems in a higher hierarchy of need. For example, a refrigerator energy allocation may operate a compressor at a slower speed and turn off electric water heater heating elements in favor of providing full power to an air conditioner or to lighting. Such integrated systems can use less energy to maximize battery life during battery usage or facilitate charging of a battery for later use.

Based on the foregoing, there is a need in the art a system, which will facilitate more efficient and optimized energy usage and increase control of electrical usage and keep critical electric appliance powered over less critical appliances.

### SUMMARY OF THE INVENTION

A system for regulating power consumption that comprises a computer control unit operating a software application, and the computer control unit associated with an electric fuse panel and breaker panel and connected to a plurality of power modules for controlling electrical power delivered to a second group of electrical appliances. The software application is used to configure the control unit with a hierarchy value of need assigned to each electrical appliance in the second group of electrical appliances, and the software application is also configured to operate on a computerized mobile device, wherein the mobile device can interface with and control the control unit, and the mobile device can provide a graphical user interface for the control unit. The control unit monitors power availability and usage from a plurality of power sources, monitors electrical usage by a first group of electrical appliances, and controls the second group of electrical appliances by decreasing the power delivered to or the needs of the second group of electrical appliances, including shutting off selected ones of the second group of electrical appliances, shutting off sub-components of selected ones of the second group of electrical appliances, or decreasing the power needs to selected ones of the second group of electrical appliances to less than the full rated normal power operating level, and the ones of the second group of electrical appliances are selected based on the assigned hierarchy value of need. The control unit decreases power to the second group or decreases need of power of electrical appliances to respond to a decrease in available power resources from the plurality of power sources.

The hierarchy value of need assigned within the second group of appliances can vary depending on a plurality of factors.

The second group of electrical appliances electrical usage is monitored by the control unit.

The plurality of power sources can comprise batteries, solar, generator, automotive alternator, and shore power/electrical grid.

At least batteries, solar, and automotive alternator can be monitored.

At least generator and shore power/electrical grid can be controlled.

The second group of appliances comprises at least one of an air conditioner, a refrigerator, a wine/water cooler, a dishwater, a hot water heater, an induction cook top, a stove hood, an electric oven, a clothes dryer, and clothes washing machine.

The first group of appliances comprises at least one of a microwave oven, a garbage disposal, ceiling fans, multiple electrical circuits, and multiple electric receptacles.

The mobile device can interface with the control unit using a short range communication connection or a wireless communication connection.

The mobile device can interface with the control unit to set and modify various control parameters, monitor power utilization and status, provide control inputs to the control unit, and provide a graphical user interface to the control unit.

The control unit operating, so that when there is an excess of power available from the solar panels, power is diverted to charge the batteries.

The control unit operating, so that when the batteries reach full charge, power is diverted back into the shore power/electrical grid circuits.

The hierarchy value of need assigned within the second group of appliances can vary depending on at least time of day.

The interface comprises a WiFi hub.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1A and B is a schematic view of the electrical components, according to an embodiment of the present invention.

### DETAILED DESCRIPTION OF PREFERRED EMBODIMENTS

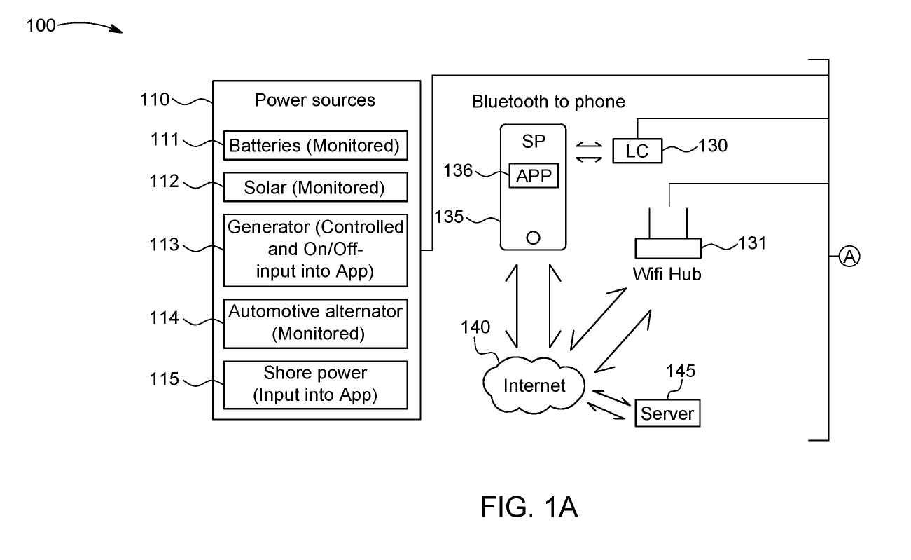

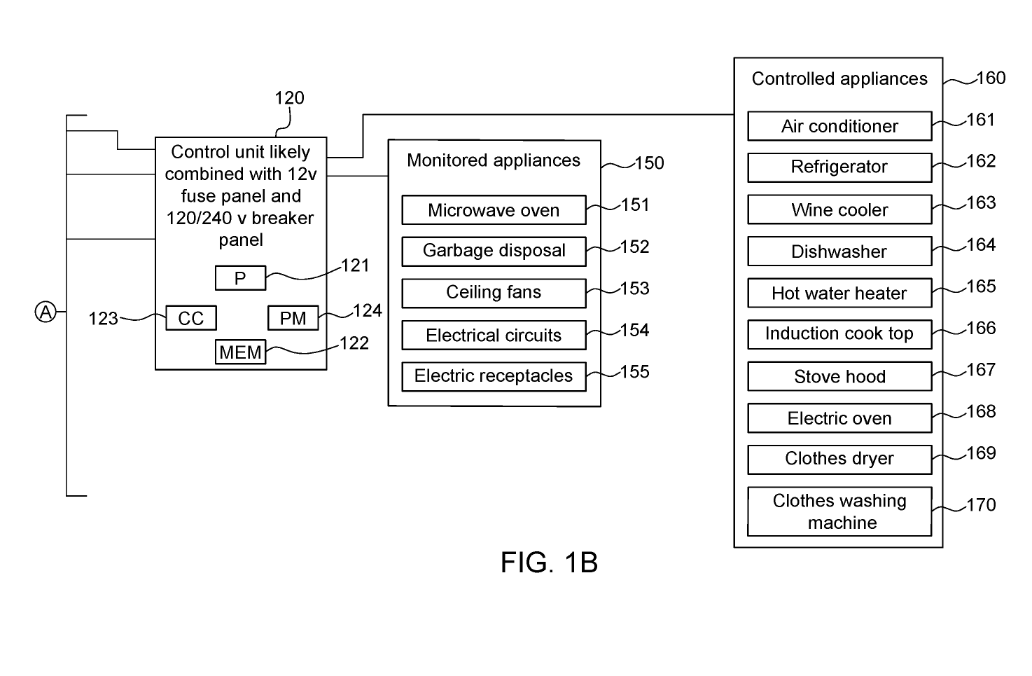

Preferred embodiments of the present invention and their advantages may be understood by referring to FIGS. 1A and B, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

The computer memories in the various disclosed devices may store computer executable instructions. Each disclosed computer/communication device such as computer, a server, a system node, a smart phone, a tablet, or similar device able to execute computer code and/or process digital, electronic data may execute computer executable instructions. The computer executable instructions may be included in computer code. The computer code may be stored in the various device memories. The computer code may be written in any computer language comprising the prior art. The memory may be a non-transitory tangible storage media. Sophisticated computer apps have increasingly become available, with downloaded executable software code (e.g., the Apple® Store) providing for configuring a mobile device, such as a smart phone, tablet, or computer to perform a plethora of functions.

The computer code may be logic encoded in one or more tangible media or one or more non-transitory tangible media for execution by the processor in the devices. Logic encoded in one or more tangible media for execution may be defined as instructions that are executable by the processor and that are provided on the computer-readable storage media, memories, or a combination thereof. Logic may include a software controlled microprocessor, an application specific integrated circuit (ASIC), an analog circuit, a digital circuit, a programmed logic device, a memory device containing instructions, and the like. The instructions may be stored on any computer readable medium comprising the prior art from which a computer, a processor, or other electronic device can read. This may include a computer data disk or the like storing computer code that can be used to configure a memory associated with a computer, a processor, or other electronic device.

The processor may include a general processor, digital signal processor, ASIC, field programmable gate array, analog circuit, digital circuit, central processing unit (CPU), micro-processor unit (MPU), micro-controller unit (MCU), combinations thereof, or other now known processor. The processor may be a single device or combinations of devices, such as associated with a network or distributed processing. The processor may be responsive to or operable to execute instructions stored as part of software, hardware, integrated circuits, firmware, micro-code or the like. The functions, acts, methods or tasks illustrated in the figures or described herein may be performed by the processor executing instructions stored in the memory.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

In an embodiment of the invention depicted in FIG. 1, a computer controlled home, vehicle, or boat based power system 100 is shown. Power sources 110 can include batteries 111 (monitored), solar 112 (monitored), generator 113 (controlled—on/off and output pulled), automotive alternator 114 (monitored), and shore power/electrical grid 115 (controlled—input/output).

Control unit 120 can include a computer with a processor (P) 121, memory (MEM) 122, and programs comprised of computer code (CC) 123, and may further include computer-controlled power modules (PM) 124 integrated with the electrical systems of the building/vehicle/boat and which may further include a fuse panel and breaker panel (e.g., 12 v, 120 v, or 240 v).

Control unit 120 can connect to a control interface, which can include a physically integrated graphical user interface (GUI), such as a touch sensitive display screen, or a remote connection.

In an embodiment, control unit 120 can use either a local communication (LC) 130, such as a Bluetooth® or other short-range communication, with a mobile device, such as a smart phone 135 or a WiFi hub 131 that can connect to the Internet 140. As depicted, the Internet can provide communication to either a server 145 or the smart phone 135. While smart phone 135 is depicted, any computerized mobile device can be used, such as a tablet or lap top computer. Smart phone 135 in turn can operate a control application (App) 136 to interface with control unit 120 to set and modify various control parameters, monitor power utilization and status, and provide control inputs to control unit 120. Smart phone 135 can also operate to provide a graphical user interface with control unit 120. Server 145 can also function to constantly interface with control unit 120 to set and modify to set and modify various control parameters, monitor power utilization and status, and provide control inputs to control unit 120, with various control and parameters likewise monitored, set, or or modified by smart phone 135 using the Internet 140. Smart phone 135 can monitor and interface with control unit 120 directly using LC 130 and wireless (e.g., WiFi) hub 131 or indirectly using server 145. A copy of App 136 can be stored in memory 122 and executed by processor 121 on control unit 120. That is, App 136 operates on both control unit 120 and smart phone 135 to create system 100 controlling power distribution.

In an embodiment, control unit 120 can interface with appliances to control and/or monitor electric usage. For example, control unit 120 can function to interface with monitored appliances 150 so as monitor electrical usage in a microwave oven 151, a garbage disposal 152, ceiling fans 153, multiple electrical circuits 154, or multiple electric receptacles 155. As a further example, control unit 120 can function to interface with controlled appliances 160 so as to monitor and control electrical usage in an air conditioner 160, a refrigerator 161, a wine/water cooler 163, a dishwater 164, a hot water heater 165, an induction cook top 166, a stove hood 167, an electric oven 168, a clothes dryer 169, and clothes washing machine 170. Such control and monitoring interfaces can be accomplished using power modules 124 to shut off, block, or reduce power delivered to the controlled appliances 160.

In an embodiment, control unit 120 can establish communication with a computer control unit in and controlling an appliance to interface with the control unit to adjust power needs and demands. For example, in many modern appliances, such as air conditioners and water heaters, a computer control unit can be accessed to reduce the power needs of the appliance. A computer control unit, as one exemplary embodiment, can operate an air conditioner at lower power levels by slowing down the compressor, slowing down the condenser fan, or slowing down the blowing fan. In another exemplary embodiments, a water heater can be controlled by a computer control unit to turn off some of the heating elements. By interfacing with an appliance control unit, the control unit 120 can adjust power needs of the appliances.

In an embodiment, the control unit 120 can control the power consumption of some key appliances 160 while monitoring different appliances 150 based on a hierarchy level of need. Additionally, control unit can monitor all available power supplies/sources 110, such as availability of battery 111 output, and can be set according to the information of maximum incoming shore power/electrical grid 115 availability. The control unit can also communicate with the user via smartphone App 136 operating on smart phone 135 (or other mobile device such as a tablet or lap top computer). The App 136 can interact with the user via smart phone 135 to both obtain necessary information and notify the user when electrical supply from one or more power sources 110 is short of demand by the electrical load (e.g., monitored appliances 150 plus controlled appliances 160).

In an embodiment, a typical envisioned use for system 100 would be in recreation vehicles, boats, tiny homes, vacation cabins, plus other situations that have a limited supply of power, to include military, law enforcement, rescue, and disaster recovery deployments (e.g., FEMA). Space systems, such as potential Mars or moon habitats and exploration could also benefit. System 100 can thus be utilized for fixed or mobile applications in any setting where conventional power resources are at a minimum and energy efficiency absolutely required.

In an embodiment, the type of appliances that this system 100 could control can be air conditioners 161, refrigerators 162, wine/water coolers 163, hot water heaters 165, dishwashers 164, electric ovens 168, microwave ovens 151, induction cooktops 166, clothes washers 170 and dryers 169, and any other appliance that could use electricity in stages rather than full on or full off. Thus, the classification of monitored appliances 150 versus controlled appliances 160 can be considered flexible, as the system 100 can be adapted as desired. The control unit 100 can also monitor devices that cannot be controlled for demand on the system 100. For example, such household appliances that are plugged into the system 100 rather than directly wired can be monitored indirectly by monitoring electrical circuits 154 or receptacles 155 including such items as toasters, coffee pots, fans, TV's, and any other appliance that is not directly integrated into system 100.

In an embodiment, when shore power/electrical grid 115 is connected, app 136 can prompt the user to set the amount of power that can be pulled from the power input (i.e., 15 amp, 30 amp, 50 amp, etc.). The app 136 can use location and time information as well as information from the controller 120 to combine incoming shore power/electrical grid 115, automotive alternator power 114 or generator power 113 with available power from storage batteries 111 and solar panel output 112 to provide the user with information regarding how long system 100 can fully power the appliances (150 and/or 160) needed.

The user can designate a hierarchy ranking of need for each of the appliances 160. The hierarchy ranking can further be based on a time of day, for example, morning, afternoon, and evening, using app 136. App 136 in turn can be used to configure control unit 120 with a hierarchy ranking of need for each controlled appliance 160, and the control unit 120 can control power distribution based on the assigned hierarchy ranking. In some embodiments, a hierarchy ranking can also be assigned to monitored appliances 150. With the available information, the controller 120 can limit the power usage of some appliances 160 that are not immediately necessary for the function of the occupied space of the recreation vehicle, boat, tiny home, vacation cabin, etc. For example, as described above, controller 120 can slow down the compressor speed of cooling appliances, such as air conditioners 161 and refrigerators 162, and reduce or turn off some heating elements to a water heater 165 equipped with multiple heating elements or reduce clothing dryer 169 heat. Additionally, control unit 120 may be able to block power to certain appliances 160, such as the electric oven 168, via the power module 124. Further, control unit 120 can detect demand spike usages from appliances 150/160 such as cooktop 166 and microwave oven 151, scaling back further other controlled appliances 160 to reduce the electrical load and usage without impacting the users in the space, and then restoring power to those appliances 160 when the demand spike event terminates. Thus, control unit 120 can use power modules 124 to reduce power to or demand from a controlled appliance to less than a rated normal power operating level or range or interface directly with a computer control unit for an appliance.

In an embodiment, as available power to the appliances 150 and 160 diminishes, control unit 120 acts to start turning off non-critical, controlled appliances 160 to keep power available for higher hierarchy ranked appliances, such as a refrigerator 162 or necessary lighting, according to the assigned hierarchy of need. The hierarchy of need can be associated with a specified time (e.g, evening for the lights).

In an embodiment, power usage can be reduced by the control unit 120 to facilitate battery 111 charging when battery 111 charge drops to a threshold. Other power resources can be increased and reallocated to facilitate charging batteries 111. Power demand from controlled appliances 160 can also be reduced to facilitate charging. If there is an excess of power from the solar panels 112, power can be diverted to batteries 111 and once batteries 111 are fully charged, the control unit 120 using App 136 can divert electricity back into the shore power/electrical grid 115 circuits. This function can be App 136 controlled.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A system for regulating power consumption, comprising:
a computer control unit operating a software application, the computer control unit associated with an electric fuse panel and breaker panel and connected to a plurality of power modules for controlling electrical power delivered to a second group of electrical appliances;
the software application used to configure the control unit with a hierarchy value of need assigned to each electrical appliance in the second group of electrical appliances;
the software application also configured to operate on a computerized mobile device, wherein the mobile device can interface with and control the control unit, and said mobile device can provide a graphical user interface for the control unit;
wherein the control unit monitors power availability and usage from a plurality of power sources, monitors electrical usage by a first group of electrical appliances, and controls the second group of electrical appliances by decreasing the power delivered to or the needs of the second group of electrical appliances, comprising shutting off selected ones of the second group of electrical appliances, shutting off sub-components of selected ones of the second group of electrical appliances, or decreasing the power needs to selected ones of the second group of electrical appliances to less than the full rated normal power operating level;
wherein the ones of the second group of electrical appliances are selected based on the assigned hierarchy value of need; and
wherein the control unit decreases power to the second group or decreases need of power of electrical appliances to respond to a decrease in available power resources from the plurality of power sources.

2. The system for regulating power consumption of claim 1, wherein the hierarchy value of need assigned within the second group of appliances varies depending on at least one factor.

3. The system for regulating power consumption of claim 1, wherein the second group of electrical appliances electrical usage is monitored by the control unit.

4. The system for regulating power consumption of claim 1, wherein the plurality of power sources comprises at least one of batteries, solar, generator, automotive alternator, and shore power/electrical grid.

5. The system for regulating power consumption of claim 4, wherein at least batteries, solar, and automotive alternator are monitored.

6. The system for regulating power consumption of claim 4, wherein at least generator and shore power/electrical grid are controlled.

7. The system for regulating power consumption of claim 1, wherein the second group of appliances comprises at least one of an air conditioner, a refrigerator, a wine/water cooler, a dishwater, a hot water heater, an induction cook top, a stove hood, an electric oven, a clothes dryer, and clothes washing machine.

8. The system for regulating power consumption of claim 1, wherein the first group of appliances comprises at least one of a microwave oven, a garbage disposal, ceiling fans, multiple electrical circuits, and multiple electric receptacles.

9. The system for regulating power consumption of claim 1, wherein the mobile device interfaces with the control unit using a short range communication connection or a wireless communication connection.

10. The system for regulating power consumption of claim 1, wherein the mobile device interfaces with the control unit to set and modify various control parameters, monitor power utilization and status, provide control inputs to the control unit, and provide a graphical user interface to the control unit.

11. The system for regulating power consumption of claim 4, further comprising:
the control unit operating, so that when there is an excess of power available from the solar panels, power is diverted to charge the batteries; and
the control unit operating, so that when the batteries reach full charge, power is diverted back into the shore power/electrical grid circuits.

12. The system for regulating power consumption of claim 1, wherein the hierarchy of needs varies depending on at least time of day.

13. The system for regulating power consumption of claim 1, wherein the interface comprises a WiFi hub.
